(19) United States
(12) Patent Application Publication
(10) Pub. No.: US 2025/0106132 A1
(43) Pub. Date: Mar. 27, 2025

(54) Extracting Temporal Patterns from Data Collected from a Communication Network

(71) Applicant: Telefonaktiebolaget LM Ericsson (publ), Stockholm (SE)

(72) Inventors: Jalil Taghia, Stockholm (SE); Valentin Kulyk, Täby (SE); Selim Ickin, Danderyd (SE); Mats Folkesson, Täby (SE); Jörgen Gustafsson, Stockholm (SE)

(21) Appl. No.: 18/729,750

(22) PCT Filed: Feb. 4, 2022
(86) PCT No.: PCT/EP2022/052716

§ 371 Date: Jul. 17, 2024

(51) Int. Cl. H04L 43/067; G06F 18/20; G06F 18/26; G06F 18/27

(52) U.S. Cl. CPC H04L 43/067; G06F 18/26; G06F 18/27; G06F 18/295

(57) ABSTRACT

Embodiments include methods for identifying communications network performance management (PM) data that is explanatory of prediction target information. Such methods include obtaining a time series of PM data representing performance of the communication network at a plurality of periodic time instances over a first duration, and based on the time series of PM data, computing a plurality of models representing a corresponding plurality of statistical characteristics of the time series of PM data. Such methods also include computing projections of the models onto the time series of PM data, and based on the projections, selecting one or more of the models that are most explanatory of the prediction target information. Various examples of time series of PM data and target information are disclosed. Other embodiments include computing apparatus configured to perform such methods.

### TECHNICAL FIELD

The present disclosure relates generally to the field of analysis of time-series data collected from a communication network, and more specifically to techniques for extracting from such data temporal patterns that are relevant to and/or explanatory of some prediction target information

### INTRODUCTION

In general, a time series is a sequence of data or information values, each of which has an associated time instance (e.g., when the data or information value was generated and/or collected). The data or information can be anything measurable that depends on time in some way, such as prices, humidity, or number of people. One important characteristic of a time series is frequency, which is how often the data values of the data set are recorded. Frequency is also inversely related to the period (or duration) between successive data values.

Time series analysis includes techniques that attempt to understand or contextualize time series data, such as to make forecasts or predictions of future data (or events) using a model built from past time series data. To best facilitate such analysis, it is preferable that the time series consists of data values measured and/or recorded with a constant frequency or period.

Time series datasets can be collected from geographic locations, such as from nodes of a communication network located in one or more geographic areas (e.g., countries, regions, provinces, cities, etc.). For example, values of performance measurement counters can be collected from the various nodes at certain time intervals. Time series data collected in this manner can be used to analyze, predict, and/or understand user behavior patterns. Furthermore, such behavior patterns can be connected to and used for detection and/or prediction of behavior consequences, such as spread of infectious disease, admittance at hospitals, consumption of goods and/or services, etc.

One important step in this process is to detect properties of the collected time series data that are closely related to the prediction target information. Different techniques can be applied for time series data mining and analysis. An example is time series clustering, which is an unsupervised data mining technique for organizing data points into groups (“clusters”) based on their similarity. Objectives include maximizing data similarity within clusters and minimizing data similarity across clusters. After time series data has been clustered, a subsequent step is selection of the time series clusters related to the prediction target information.

### SUMMARY

In many cases, however, not all the time series data collected from a communication network is relevant for a problem and/or prediction target information. If the data is viewed as collection of temporal patterns, different ones of the temporal patterns will be useful for different prediction target information. Thus, there is a need to identify the most relevant patterns and extract the data corresponding to those patterns, e.g., for use in analysis and/or prediction.

Accordingly, embodiments of the present disclosure address these and other problems, issues, and/or difficulties by providing techniques for identification and extraction of temporal patterns for a prediction target information in an unsupervised manner.

Some embodiments of the present disclosure include methods (e.g., procedures) for identifying communication network performance management (PM) data that is explanatory of prediction target information.

These exemplary methods can include obtaining a time series of PM data representing performance of the communication network at a plurality of periodic time instances over a first duration. These exemplary methods can also include, based on the time series of PM data, computing a plurality of models (also referred to herein as “disentangled concepts”) representing a corresponding plurality of statistical characteristics of the time series of PM data. These exemplary methods can also include computing projections of the models onto the time series of PM data. These exemplary methods can also include, based on the projections, selecting one or more of the models that are most explanatory of the prediction target information.

In some embodiments, each model is computed as one of the following:
a Hidden Markov Model (HMM) with a plurality of emission states having distributions according to Gaussian Mixture Models (GMM);
a Dirichlet distribution;
a von Mises-Fisher distribution; or
linear or non-linear equation.

In some of these embodiments, the plurality of emission states of the HMM correspond to a respective plurality of clusters of the time series of PM data. Furthermore, computing projections of the models onto the time series of PM data includes computing the projection of each model based on a product of the following at each time instance over the first duration: the time series of PM data, and the posterior probabilities of the respective emission states of the HMM for the model.

In some embodiments, computing the plurality of models is further based on data representative of factors external to the communication network. In some of these embodiments, computing the plurality of models scaling or transforming the time series of PM data using the data representative of the external factors. In some variants, the time series of PM data is scaled or transformed based on a function representative of effects of the external factors on a relation between the time series of PM data and the prediction target information.

In some embodiments, selecting one or more of the models based on the projections includes the following operations: for each projection, calculating interaction information for data including the projection and the prediction target information; and selecting a subset of the models corresponding to a subset of the projections whose calculated interaction information meets one or more criteria.

In some of these embodiments, each projection represents a temporal pattern of the time series of PM data that is associated with the corresponding model, and the interaction information for each projection is calculated based on a joint entropy among the temporal pattern of the time series of PM data and the prediction target information.

In other of these embodiments, selecting one or more of the models based on the projections can also include separating the projections into first and second subsets, with projections of the first subset having greater interaction information than projections of the second subset. In such case, the first subset is selected based on having greater interaction information.

In other of these embodiments, the interaction information for each projection includes the following: first interaction information for the projection; second interaction information for the projection and the prediction target information; and information gain from the first interaction information to the second interaction information. In such embodiments, selecting one or more of the models based on the projections can also include separating the projections into first and second subsets, with projections of the first subset having greater information gain than projections of the second subset. In such case, the first subset is selected based on having greater information gain.

In other embodiments, selecting one or more of the models based on the projections includes the following operations: for each projection, calculating a correlation between the projection and the prediction target information; and selecting a subset of the models corresponding to a subset of the projections whose calculated correlation meets one or more criteria. In some of these embodiments, selecting one or more of the models based on the projections can also include separating the projections into first and second subsets, with projections of the first subset having greater correlation than projections of the second subset. In such case, the first subset is selected based on having greater correlation.

In various embodiments summarized above, the first and second subsets can be separated based on a predetermined one of the following: number of projections to be included in the first subset, interaction information threshold, information gain threshold, or correlation threshold.

In some embodiments, the prediction target information is patients admitted to hospital and the time series of PM data includes samples of a plurality PM counters for each a plurality of base stations at different locations in the communication network and for each of the plurality of periodic time instances over the first duration. For example, the plurality of PM counters can include any of the following: number of active users in uplink, number of active users in downlink, total number of handovers, and total duration of all UE sessions in an area during a time interval.

In other embodiments, the prediction target information is end-to-end (E2E) latency, E2E throughput, and/or energy usage for the communication network. Also, the time series of PM data includes samples of key performance indicators (KPIs) for each of a plurality of network nodes or network functions (NFs) within the communication network and for each of the plurality of periodic time instances over the first duration. In some of these embodiments, obtaining the time series of PM data can include grouping the time series of PM data according to geo-location of the respective network nodes or NFs. In such embodiments, the plurality of models are computed based on the time series of PM data grouped according to geo-location.

In some embodiments, computing the plurality of models is further based on data representative of factors external to the communication network, including one or more of the following associated with the first duration: forecast or actual weather, days of the week, month of the year, season of the year, public events or demonstrations, road usage or traffic, public transportation usage, power outages, public health information, and shopping or other commerce-related information.

Other embodiments include various computing apparatus (e.g., NF, AF, cloud computing apparatus or system, etc.) configured to perform operations corresponding to the exemplary methods summarized above. Other embodiments include non-transitory, computer-readable media storing computer-executable instructions that, when executed by processing circuitry, configure a computing apparatus to perform operations corresponding to the exemplary methods summarized above.

These and other embodiments described herein can provide a modular framework in which individual modules can be updated according to changes in available technology. Embodiments are scalable for “big data” applications including large communication networks, and allow for end-to-end incorporation of external factors into forecast models. Furthermore, outputs of various embodiments (i.e., models or “disentangled concepts” of interest) can be used for the construction of the forecast models, KPI predictors, and similar machine learning (ML) use cases.

These and other objects, features, and advantages of the present disclosure will become apparent upon reading the following Detailed Description in view of the Drawings briefly described below.

### BRIEF DESCRIPTION OF THE DRAWINGS

FIG. 1 shows a high-level block diagram of an exemplary modular arrangement for extracting temporal patterns from performance management (PM) data collected from a communication network, according to various embodiments of the present disclosure.

FIG. 2 shows a high-level block diagram of a computing apparatus having modular functionality corresponding to the exemplary technique or arrangement shown in FIG. 1, according to various embodiments of the present disclosure.

FIG. 3 shows a high-level block diagram of more specific embodiments of the exemplary technique or arrangement shown in FIG. 1.

FIG. 4 shows a block diagram of a Hidden Markov Model (HMM) with a plurality of emission states having distributions according to Gaussian Mixture Models (GMM), such as used in FIG. 3 and other embodiments described herein.

FIGS. 5-6 show flow diagrams of exemplary usage scenarios for various embodiments of the present disclosure.

FIG. 7 is a block diagram of an exemplary 5G network.

FIG. 8 shows a flow diagram of another exemplary usage scenario for various embodiments of the present disclosure.

FIG. 9 illustrates an exemplary method (e.g., procedure) for a computing apparatus, according to various embodiments of the present disclosure.

FIG. 10 show an exemplary communication network in which various embodiments of the present disclosure can be implemented.

FIG. 11 shows an exemplary computing system in which various embodiments of the present disclosure can be implemented.

FIG. 12 is a block diagram of a virtualization environment in which various embodiments of the present disclosure may be virtualized.

### DETAILED DESCRIPTION

Embodiments briefly summarized above will now be described more fully with reference to the accompanying drawings. These descriptions are provided by way of example to explain the subject matter to those skilled in the art and should not be construed as limiting the scope of the subject matter to only the embodiments described herein. More specifically, examples are provided below that illustrate the operation of various embodiments according to the advantages discussed above.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods and/or procedures disclosed herein do not have to be performed in the exact order disclosed, unless a step is explicitly described as following or preceding another step and/or where it is implicit that a step must follow or precede another step. Any feature of any of the embodiments disclosed herein can be applied to any other embodiment, wherever appropriate. Likewise, any advantage of any of the embodiments can apply to any other embodiments, and vice versa.

Time series data collected from a communication network can be used in various important in real-world prediction applications. In many cases, however, not all of the time series data collected from a communication network is related to a particular problem for which a prediction is needed and/or particular information to be predicted, which can be collectively referred to as “prediction target information.”

Principal component analysis (PCA) has been used to infer relevant patterns from data. PCA is a type of multivariate data analysis that is based on projection methods. For example, PCA can be used to represent a multivariate data set as smaller set of variables (“summary indices” or “principal component”) that can indicate characteristics of the full data set such as trends, jumps, clusters, and outliers. These summary indices can also indicate relationships among variables as well as between observations and variables. Statistically, PCA finds lines, planes and hyper-planes in the K-dimensional data space that approximate the data as well as possible in the least squares sense. At a high level, the principal components explain (to some degree) the variance in the data set.

Independent component analysis (ICA) has also been used to infer relevant patterns from data, but from a different perspective or approach. In particular, the independent components are selected such that the mutual information between any pair of the independent components is minimized. ICA is based on two key assumptions, namely that the independent components to be identified are statistically independent of each other and have non-Gaussian random distributions.

PCA is often used to compress information by reducing its dimensionality, while ICA aims to separate information by transforming the input space into a maximally independent set of components. A commonality is that both PCA and ICA require each data variable to be auto-scaled by its mean and standard deviation before the components are identified. However, neither PCA nor ICA considers temporal dependencies in a data set. Rather, they require that the respective data samples are independent and identically distributed (i.i.d.), which is often not the case for real-world data such as collected from communication networks.

Representation learning (RL) methods extract representations of features from unlabeled data by training a neural network (NN) on a secondary, supervised learning task. One RL technique is an autoencoder (AE), which is a type of artificial neural network (NN) used to compress data in an unsupervised manner. AEs are based on the encoder-bottleneck-decoder structure. The AE encoder reduces the dimensionality of the input features with increasing depth of the NN. The output of the AE encoder (so-called “bottleneck layer” of the NN) is the code values representing the features. The AE decoder attempts to invert the encoder and reconstruct the original input data from the code values with minimal error according to some loss function.

However, RL techniques such as AEs do not implicitly consider the output target responses. While techniques such as conditional AEs can be used to infer representations of data that are relevant to some target outputs, they do not consider temporal dependencies. Even so, Long Short-Term Memory (LSTM) networks can be used with an AE to capture some temporal dependences in the input data.

Nevertheless, none of the techniques discussed above consider the “explainability” of a prediction generated by an ML model based on a dataset (e.g., collected from a communication network). If the data set is viewed as collection of temporal patterns, different ones of the temporal patterns will be useful for different prediction target information. There is a need to identify the most relevant patterns and extract the data corresponding to those patterns with respect to particular prediction target information. Understanding which data that a model uses to generate a prediction leads to explainability, which is important both for debugging the model and ultimately for trust in the model.

Accordingly, embodiments of the present disclosure overcome these problems, issues, and/or difficulties techniques that extract from data collected from a communication network some temporal patterns that are explanatory of prediction target information. For example, the techniques can be embodied in several functional modules that can be implemented by various combinations of hardware and software. More specifically, such modules include:
Concept Learner module, which learns disentangled concepts from the collected data. Each disentangled concept can be modelled by an underlying random distribution that describes some unique statistical characteristic(s) of the concept.
Concept Projector module, which projects the collected data through the disentangled concepts to obtain temporal patterns.
Concept Selector module, which selects the disentangled concepts of interest based on the projections—particularly the disentangled concepts that are most explanatory of the target responses.

Embodiments can provide various benefits and/or advantages. For example, the modular arrangement discussed above can be seen as a framework that does not depend on the specific implementations of the individual modules. Individual modules can be updated according to changes in available technology. Also, the technique is scalable for “big data” applications including large communication networks and allows allows for end-to-end incorporation of external factors into forecast models. Furthermore, the output of the technique (i.e., disentangled concepts of interest) can be used for the construction of the forecast models, KPI predictors, and similar machine learning (ML) use cases.

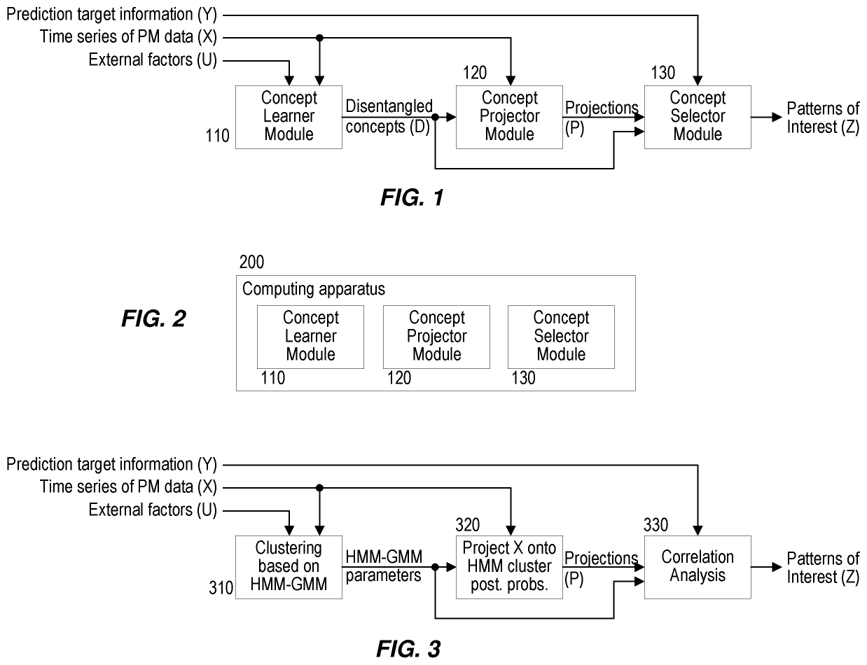

FIG. 1 shows a high-level block diagram of an exemplary modular arrangement for extracting temporal patterns from performance management (PM) data collected from a communication network, according to various embodiments of the present disclosure. The modular arrangement includes a Concept Learner Module (110), a Concept Projector Module (120), and a Concept Selector Module (130). FIG. 2 shows a high-level block diagram of a computing apparatus having modular functionality corresponding to the exemplary technique or arrangement shown in FIG. 1, according to various embodiments of the present disclosure.

The Concept Learner Module receives as input a time series of PM data (denoted “X”) collected from a communication network (e.g., 5G network) over some duration of time. Various examples of such time series of PM data are discussed below. In some embodiments, the Concept Learner Module also receives as input data (denoted “U”) representative of factors external to the communication network (also referred to as “external factors”). For example, U can include data pertaining to various external factors over the same duration as the time series of PM data (X). As more specific examples, U can include data representative of forecast or actual weather, days of the week, month of the year, season of the year, public events or demonstrations, road usage or traffic, public transportation usage, power outages, public health information (e.g., numbers or rates of vaccination, numbers or rates of positive tests for virus, numbers or rates of hospitalization, etc.), and shopping or other commerce-related information (e.g., number of store visitors, amount of sales, etc.).

The Concept Learner Module extracts disentangled concepts (denoted “D”) from the time series of PM data and provides these to the Concept Projector Module. In general, a “disentangled concept” refers to a model that represents an independent factor, characteristic, or aspect of a data set (e.g., the time series of PM data) that preferably also corresponds to a natural concept understood by humans. Put differently, given the data set X, the Concept Learner Module determines a set of independent factors that produce X.

For example, each disentangled concept Dᵢ may be modelled by a probability distribution that describes some unique statistical characteristic of the data set X. Different probability distributions can be chosen according to the characteristics of interest and/or the data set. Some example distributions include Hidden Markov Model (HMM) with emission states having distributions according to Gaussian Mixture Models (GMM), Dirichlet distribution (e.g., for bounded data), and von Mises-Fisher distribution (e.g., for directional data). An example based on HMM-GMM is discussed in more detail below in the description of FIG. 3. Alternately, a disentangled concept can be a mathematical model (e.g., linear or non-linear equation).

The degree or amount of disentanglement provided by a determined set of disentangled concepts can be evaluated based on informativeness, independence (or separability), and interpretability. Informativeness of a disentangled concept Dᵢ (e.g., represented by a probability distribution) can be measured in a statistical sense by the mutual information between Dᵢ and the data set X. Independence between different disentangled concepts (e.g., D₁, D₂) can be measured in a statistical sense by the mutual information among the different disentangled concepts and the data set X, with complete independence indicated by zero mutual information. Likewise, interpretability measures the degree of correspondence between a disentangled concept Dᵢ (e.g., represented by a probability distribution) and a particular human-defined concept Cᵢ. For example, Dᵢ Is interpretable with respect to Cᵢ and if Dᵢ only contains information about Cᵢ and not about other human-defined concepts of interest.

Skilled persons will have knowledge of these and other aspects of disentangled representations of a data set X, e.g., based on descriptions found in non-patent literature such as “Theory and evaluation metrics for learning disentangled representations” by Do and Tran in International Conference on Learning Representations, 2020.

In some embodiments, the time series of PM data X may need to be scaled or transformed based on the external factors data U. This can be done, for example, by the Concept Learner Module. For example, the time series of PM data X can be scaled or transformed based on a function representative of effects of the external factors on a relation between the time series of PM data X and the prediction target information Y. As a more specific example, the external factors may make a relationship between X and Y weaker. If this adverse effect is known, a linear or non-linear function X←ƒ(X, U) can be used to compensate for it. In some cases, the function may be determined empirically. The Concept Learner Module will extract the disentangled concepts (D) from the compensated time series of PM data.

The Concept Projector Module projects the disentangled concepts (D) received from the Concept Learner Module onto the time series of PM data (X), resulting in projections (P) that are output to the Concept Selector Module. At a high level, the functionality of this module can be viewed as decomposition of the time series of PM data into several temporal patterns. In other words, each projection (e.g., Pᵢ) represents a temporal pattern of the time series of PM data that is associated with the corresponding disentangled concept (e.g., Dᵢ). A projection Pᵢ can be a statistical projection when the underlying model describing disentangled concept Dᵢ is a statistical model. Likewise, the projection Pᵢ can be a mathematical projection when the underlying model describing disentangled concept Dᵢ is a mathematical model. An example projection based on HMM-GMM is discussed in more detail below in the description of FIG. 3.

The Concept Selector Module receives as input the prediction target information (Y) and the model-based projections (P) of the time-series PM data (X) output provided by the Concept Projector module. It then selects one or more of the projections that best explain the prediction target information (Y). This output is also referred to as the pattern(s) of interest (denoted “Z”). In general, the Concept Selector Module can separate the projections into first and second subsets according to one or more criteria and select the first subset as the pattern(s) of interest (Z).

In some embodiments, the Concept Selector Module can use interaction information to select the one or more of the projections that best explain the prediction target information (Y). Interaction information is a generalization of the statistical property of mutual information for more than two variables. Interaction information expresses the amount of information (redundancy or synergy) present in a set of variables, beyond that which is present in any subset of those variables. Unlike mutual information, the interaction information can be positive or negative.

Interaction Information can also be understood as a nonlinear generalization of correlation between any number of attributes. A positive value of interaction information can indicate phenomena such as correlation or moderation, where one attribute affects the relationship of other attributes. On the other hand, a negative value of interaction information can indicate mediation, where one or more of the attributes (at least partially) convey information already conveyed by other attributes.

One or more of the following statistical metrics can be computed by the Concept Selector Module when using interaction information to select the one or more of the projections that best explain the prediction target information (Y):
H_{y}=H (Y), entropy of prediction target information Y.
CIⱼ=Int (Pⱼ), interaction information for the j-th projection excluding Y.
CYIᵢ=Int (Pⱼ, Y), interaction information for the j-th projection and Y.
MIⱼ=CYIⱼ/H_{y}, interaction information for the j-th projection and Y, normalized by the entropy of the prediction target.
IGⱼ=(CYIⱼ−CIⱼ), information gain for the j-th projection from addition of the prediction target Y.
   Persons skilled in the relevant technical field will be familiar with how these statistical metrics are computed.

In some embodiments, the Concept Selector Module can separate projections into subsets based on the corresponding values of interaction information CYIⱼ with projections of the first subset having greater interaction information than projections of the second subset. In other words, the Concept Selector Module selects some subset of the projections that have greater interaction information than the remainder of the projections.

In other embodiments, the Concept Selector Module can separate projections into subsets based on the corresponding values of information gain IGⱼ with projections of the first subset having greater information gain than projections of the second subset. In other words, the Concept Selector Module selects some subset of the projections that have greater information gain than the remainder of the projections.

In other embodiments, the Concept Selector Module can use correlation analysis to select the one or more of the projections that best explain the prediction target information (Y). For J projections and time series of PM data collected at T instances, P is a JxT-dimensional matrix where each column j=1 . . . . J is a projection Pj. Assume that prediction target information (Y) is a vector of length T. The Pearson correlation score rj for projection Pj is computed as:

$${r}_{j} = \frac{n ( \sum {P}_{j} \cdot Y ) - ( \sum {P}_{j} ) ( \sum Y )}{\sqrt{[ n \sum {P}_{j}^{2} - {( \sum {P}_{j} )}^{2} ] [ n \sum {Y}^{2} - {( \sum Y )}^{2} ]}}$$

where “⋅” is element-by-element multiplication of vectors and the power of 2 is element-by-element square of a vector. As an alternative metric, the Concept Selector Module can compute a Spearman correlation score for each projection Pj. The Spearman correlation score is a non-parametric alternative to Pearson's correlation that is particularly applicable for data sets that have curvilinear, monotonic relationships or contain ordinal (discrete) data.

In some embodiments, the Concept Selector Module can separate projections into subsets based on the corresponding values of correlation score rᵢ with projections of the first subset having greater correlation score than projections of the second subset. In other words, the Concept Selector Module selects some subset of the projections that have greater correlation score than the remainder of the projections.

In any of the above-described embodiments, the Concept Selector Module can separate the first and second subsets based on any relevant criteria, such as a predetermined number of projections to be included in the first subset, a predetermined interaction information threshold, a predetermined information gain threshold, or a predetermined correlation threshold.

FIG. 3 shows a high-level block diagram of more specific embodiments of the exemplary technique or arrangement shown in FIG. 1. In this arrangement, the Concept Learner Module (310) performs clustering of the time-series PM data based on a HMM with a plurality of emission states having distributions according to GMMs, such as briefly mentioned above.

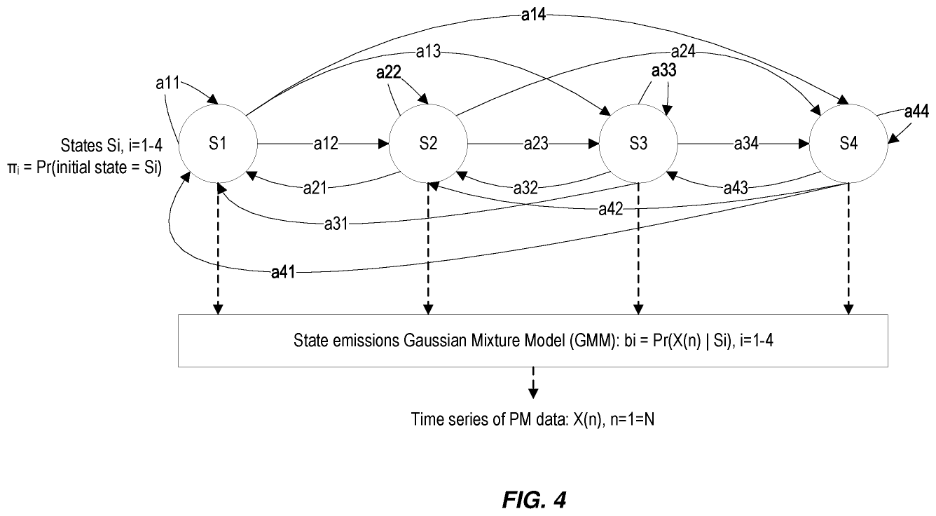

FIG. 4 shows a block diagram of an exemplary HMM with four (4) emission states having distributions according to GMMs, such as used in FIG. 3 and other embodiments described herein. The following parameters define this statistical model:
States, Si, i=1 . . . 4—each state corresponds to a cluster of the time series of PM data X)
Initial state distribution vector, π, where πᵢ is the probability that the initial state is Si.
Transition probability matrix, A, where ajk is the entry in the jth row and kth column of A and represents the probability of a transition from state Sj to state Sk. Each row and each column add to unity. Note that some portion of ajk may be zero, meaning that there is zero probability of transitioning between the corresponding states. An arrangement in which all ajk are non-zero is referred to as an “ergodic topology.”
Emission probability distributions, B, where bi is the emission probability distribution for state Si. In other words, bi indicates the probability of state Si emitting each of the possible values of the time series of PM data, including but not limited to the actual collected time series of PM data (X). If each sample of time series of PM data includes values for multiple communication network parameters (e.g., counters in different nodes), emission distribution bi for Si will be a multi-variate probability distribution, such as a multi-variate Gaussian distribution.

The assumption that a single multivariate Gaussian emission distribution can model the probability of outputs of any state of a HMM is often inaccurate. Instead, a more powerful approach is to represent the HMM state emission distribution as a mixture of multiple multivariate Gaussian densities. In other words, emission distribution bi for Si will be a weighted mixture of K multivariate Gaussian densities. This is referred to as a Gaussian Mixture Model (GMM), and can be completely characterized by K mixture weights, K mean vectors, and K covariance matrices corresponding to the respective K constituent multivariate Gaussian densities.

In the arrangement shown in FIG. 3, the plurality of emission states of the HMM for each disentangled concept correspond to a respective plurality of clusters of the time series of PM data. In the context of the example shown in FIG. 4, there are four clusters of time series of PM data corresponding to the four states of the HMM, S1-S4. For each disentangled concept Dᵢ, the Concept Learner Module outputs the HMM-GMM parameters, such as state (or cluster) posterior probabilities associated with each sample (or time instance) of the time series of PM data.

As an example, for J HMM states (or clusters) and T time instances of interest, Q is a JxT-dimensional matrix where each entry qij represents the posterior probability that state (or cluster) Si generated an emission at the jth time instance. Assume that the time series of PM data (X) is a length-T vector. For disentangled concept Di represented by a HMM, the Concept Projector Module (320) projects the time series of PM data onto the representative HMM according to:

$$Pi = Q \cdot X ,$$

where projection Pi is also a JxT-dimensional matrix in which each row is an element-by-element product of X and a row of Q (i.e., corresponding to a state or cluster).

The Concept Selector Module (330) receives the projections (P) from the Concept Projector Module and performs correlation analysis between the projections and the prediction target information (Y). For example, the Concept Selector Module can compute a Pearson correlation score rj for each projection Pj in the manner described above. The Concept Selector Module can select as the patterns of interest (Z) the subset of the projections that are most correlated with the prediction target information (either positively or negatively, according to the respective correlation scores).

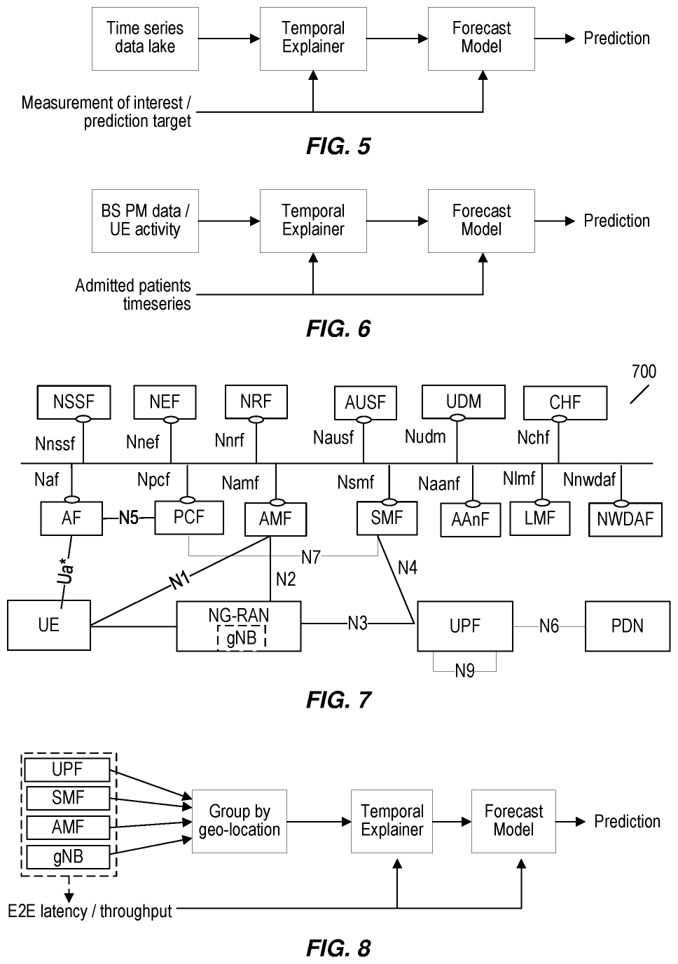

FIG. 5 shows a flow diagram for an exemplary usage scenario for various embodiments described above. In particular, FIG. 5 illustrates an arrangement in which a Temporal Explainer extracts from time series data one or more temporal patterns that explain a prediction target, which is measured separate from the time series data. In this scenario, the time series data can be performance management (PM) data collected at different geographical locations (e.g., base stations, routers, network functions) within a communication network (e.g., NG-RAN, 5GC). The prediction target relates to condition(s) and/or problem(s) in the communication network. It is desirable to exclude parts of the collected measurements that are irrelevant to the prediction target.

The prediction target information can be used as data request input to the Temporal Explainer, which based on the request selects the relevant data from the time series “data lake” of network measurements. In particular, the Temporal Explainer selects one or more temporal patterns of time series data (e.g., as patterns of interest, Z) that explain the prediction target, such as by using techniques described above.

In this manner, the Temporal Explainer provides relevant data that is useful for a forecast modelling pipeline and/or directly by a forecast model. For example, the forecast model can perform additional feature selection and tuning before training and generation of prediction within desired forecast window.

FIG. 6 shows a flow diagram for another exemplary usage scenario for various embodiments described above. In particular, FIG. 6 illustrates a prediction of patients admitted to a hospital in an epidemic or pandemic situation.

PM counters collected from base stations of the wireless network can be used for definition of thresholds for counts of active UEs in different geo locations. Some exemplary PM counters include pmActiveUeDISum, pmCellHoExeSuccLteInterF, pmCellHoExeSuccLteIntraF, pmActiveUeDISum, pmActiveUeUlSum, pmActiveUeDISum, and pmsessionTimeUe. These PM counters can also be combined in various functions, such as:
Handover (HO)=SUM (pmCellHoExeSuccLteInterF, pmCellHoExeSuccLteIntraF)
DL/UL Ratio=pmActiveUeDISum/pmActiveUeUlSum
Session Ratio=pmActiveUeDISum/pmsession TimeUe
   Some or all of these PM counters and/or functions can be combined to define a level of UE activity, e.g., pmActiveUeDISum+HO.

The PM data collected from base stations at different geo-locations and the collected PM data time series are transformed into UE-activity time series data, which is input to the Temporal Explainer together with the admitted patients counts as the prediction target. The Temporal Explainer selects one or more temporal patterns of the UE-activity time series data (e.g., as patterns of interest, Z) that explain the prediction target, such as by using techniques described above. The selected temporal patterns that explain the admitted patient counts are used by a forecast model to generate a prediction of admitted patients.

Embodiments of the present disclosure are also applicable to prediction of communication network key performance indicators (KPIs) for specific subsets of the network, such as per cell or per slice of network functionality, also referred to as “network slice”. For example, embodiments can be used with a 5G network such as described below. Note that a “network slice” is a logical partition of a 5G network that provides specific network capabilities and characteristics, e.g., in support of a particular service. A network slice instance is a set of network function (NF) instances and the required network resources (e.g., compute, storage, communication) that provide the capabilities and characteristics of the network slice.

At a high level, the 5G System (5GS) includes a Next-Generation Radio Access Network (NG-RAN) and a 5G Core Network (5GC). The NG-RAN provides user equipment (UEs) with connectivity to the 5GC, e.g., via base stations such as gNBs or ng-eNBs described below. The 5GC includes a variety of Network Functions (NFs) that provide a wide range of different functionalities such as session management, connection management, charging, authentication, etc. Traditional peer-to-peer interfaces and protocols found in earlier-generation networks are modified and/or replaced by a Service Based Architecture (SBA) in which NFs provide one or more services to one or more service consumers. In general, the various services are self-contained functionalities that can be changed and modified in an isolated manner without affecting other services.

FIG. 7 shows an exemplary reference architecture for a 5G network (700) with service-based interfaces and various 3GPP-defined NFs, including the following:
Application Function (AF, with Naf interface) interacts with the 5GC to provision information to the network operator and to subscribe to certain events happening in operator's network. An AF offers applications for which service is delivered in a different layer (i.e., transport layer) than the one in which the service has been requested (i.e., signaling layer), the control of flow resources according to what has been negotiated with the network. An AF communicates dynamic session information to PCF (via N5 interface), including description of media to be delivered by transport layer.
Policy Control Function (PCF, with Npcf interface) supports unified policy framework to govern the network behavior, via providing PCC rules (e.g., on the treatment of each service data flow that is under PCC control) to the SMF via the N7 reference point. PCF provides policy control decisions and flow based charging control, including service data flow detection, gating, QoS, and flow-based charging (except credit management) towards the SMF. The PCF receives session and media related information from the AF and informs the AF of traffic (or user) plane events.
User Plane Function (UPF)-supports handling of user plane traffic based on the rules received from SMF, including packet inspection and different enforcement actions (e.g., event detection and reporting). UPFs communicate with the RAN (e.g., NG-RNA) via the N3 reference point, with SMFs (discussed below) via the N4 reference point, and with an external packet data network (PDN) via the N6 reference point. The N9 reference point is for communication between two UPFs.
Session Management Function (SMF, with Nsmf interface) interacts with the decoupled traffic (or user) plane, including creating, updating, and removing Protocol Data Unit (PDU) sessions and managing session context with the User Plane Function (UPF), e.g., for event reporting. For example, SMF performs data flow detection (based on filter definitions included in PCC rules), online and offline charging interactions, and policy enforcement.
Charging Function (CHF, with Nchf interface) is responsible for converged online charging and offline charging functionalities. It provides quota management (for online charging), re-authorization triggers, rating conditions, etc. and is notified about usage reports from the SMF. Quota management involves granting a specific number of units (e.g., bytes, seconds) for a service. CHF also interacts with billing systems.
Access and Mobility Management Function (AMF, with Namf interface) terminates the RAN CP interface and handles all mobility and connection management of UEs (similar to MME in EPC). AMFs communicate with UEs via the N1 reference point and with the RAN (e.g., NG-RAN) via the N2 reference point.
Network Exposure Function (NEF) with Nnef interface-acts as the entry point into operator's network, by securely exposing to AFs the network capabilities and events provided by 3GPP NFs and by providing ways for the AF to securely provide information to 3GPP network. For example, NEF provides a service that allows an AF to provision specific subscription data (e.g., expected UE behavior) for various UEs.
Network Repository Function (NRF) with Nnrf interface-provides service registration and discovery, enabling NFs to identify appropriate services available from other NFs.
Network Slice Selection Function (NSSF) with Nnssf interface-enables other NFs (e.g., AMF) to identify a network slice instance that is appropriate for a UE's desired service.
Authentication Server Function (AUSF) with Nausf interface-based in a user's home network (HPLMN), it performs user authentication and computes security key materials for various purposes.
Network Data Analytics Function (NWDAF) with Nnwdaf interface-provides network analytics information (e.g., statistical information of past events and/or predictive information) to other NFs on a network slice instance level. The NWDAF can collect data from any 5GC NF.
Location Management Function (LMF) with Nlmf interface-supports various functions related to determination of UE locations, including location determination for a UE and obtaining any of the following: DL location measurements or a location estimate from the UE; UL location measurements from the NG RAN; and non-UE associated assistance data from the NG RAN.
   In some cases, 5GC control plane functions (e.g., AMF and SMF) can be implemented in a packet core controller (PCC) and the 5GC UPF can be implemented in a packet core gateway (PCG).

The Unified Data Management (UDM) function supports generation of 3GPP authentication credentials, user identification handling, access authorization based on subscription data, and other subscriber-related functions. To provide this functionality, the UDM uses subscription data (including authentication data) stored in the 5GC unified data repository (UDR). In addition to the UDM, the UDR supports storage and retrieval of policy data by the PCF, as well as storage and retrieval of application data by NEF.

The NG-RAN can include one or more gNodeB's (gNBs) connected to the 5GC via one or more NG interfaces. More specifically, gNBs can connected to one or more AMFs in the 5GC via respective NG-C interfaces and to one or more UPFs in the 5GC via respective NG-U interfaces. In addition, the gNBs can be connected to each other via one or more Xn interfaces. The radio technology for the NG-RAN is often referred to as “New Radio” (NR). With respect the NR interface to UEs, each of the gNBs can support frequency division duplexing (FDD), time division duplexing (TDD), or a combination thereof. Each of the gNBs can serve a geographic coverage area including one or more cells and, in some cases, can also use various directional beams to provide coverage in the respective cells.

NG-RAN nodes such as gNBs can include a Central Unit (CU or gNB-CU) and one or more Distributed Units (DU or gNB-DU). CUs are logical nodes that host higher-layer protocols and perform various gNB functions such controlling the operation of DUs, which are decentralized logical nodes that host lower layer protocols. CUs and DUs can have different subsets of gNB functionality, depending on implementation. Each CU and DU can include various circuitry needed to perform their respective functions, including processing circuitry, transceiver circuitry (e.g., for communication), and power supply circuitry. A gNB-CU connects to one or more gNB-DUs over respective F1 logical interfaces. A gNB-CU and connected gNB-DU(s) are only visible to other gNBs and the 5GC as a gNB, i.e., the F1 interface is not visible beyond gNB-CU.

FIG. 8 shows a flow diagram for another exemplary usage scenario for various embodiments described above. In particular, FIG. 8 illustrates a prediction of KPIs for specific subsets of a 5G network, such as per cell or per network slice.

In this exemplary scenario, KPI timeseries data needs to be predicted based on a large number of PM data or KPIs collected from the 5G network. As an example, end-to-end (E2E) latency and/or E2E throughput can be prediction targets in this scenario. The time series of PM data is collected from different network nodes or NFs within the 5G network. For example, the service assurance for a 5G slice the data can be collected from gNBs, AMF and SMF in a PCC, and UPF in a PCG. The prediction target KPI can be part of the collected PM data or measured independently (e.g., for E2E latency use case).

The collected time series of PM data can be grouped by geo-location, with the grouped data being input to the Temporal Explainer together with the prediction target KPI. The Temporal Explainer selects one or more temporal patterns of the time series of PM data (e.g., as patterns of interest, Z) that explain the prediction target, such as by using techniques described above. The selected time series PM clusters explaining the prediction target are consumed by a forecast model to generate a prediction of the relevant KPIs.

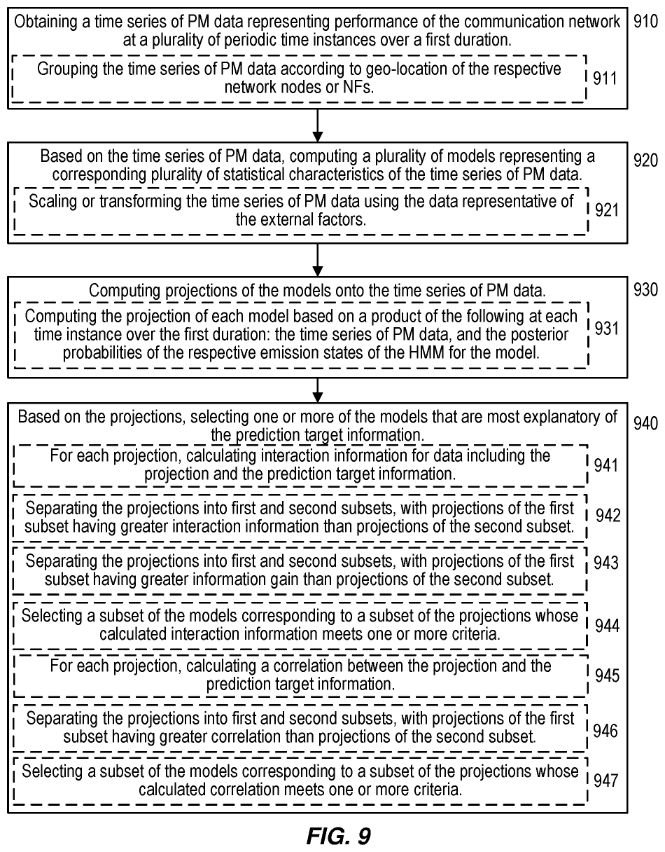

The embodiments described above can be further illustrated with reference to FIG. 9, which depicts an exemplary method (e.g., procedures) for identifying communication network performance management (PM) data that is explanatory of prediction target information, according to various embodiments of the present disclosure. Put differently, various features of the operations described below correspond to various embodiments described above. Although the exemplary method is illustrated in FIG. 9 by specific blocks in a particular order, the operations corresponding to the blocks can be performed in a different order than shown and can be combined and/or divided into blocks having different functionality than shown. Optional blocks and/or operations are indicated by dashed lines.

The exemplary method illustrated by FIG. 9 can be performed by any appropriate computing apparatus that is configured to obtain PM data and perform the operations, calculations, etc. comprising various embodiments of the exemplary method. For example, the computing apparatus can be a NF in the communication network (e.g., NWDAF), an application function (AF) associated with the communication network, or a cloud-based computing apparatus or system. Other example computing apparatus are discussed below in relation to other figures.

The exemplary method can include the operations of block 910, where the computing apparatus can obtain a time series of PM data representing performance of the communication network at a plurality of periodic time instances over a first duration. The exemplary method can also include the operations of block 920, where the computing apparatus can, based on the time series of PM data, compute a plurality of models (also referred to herein as “disentangled concepts”) representing a corresponding plurality of statistical characteristics of the time series of PM data. The exemplary method can also include the operations of block 930, where the computing apparatus can compute projections of the models onto the time series of PM data. The exemplary method can also include the operations of block 940, where the computing apparatus can, based on the projections, select one or more of the models that are most explanatory of the prediction target information.

Some examples of these operations were described above. For example, concept learner module 110 of FIGS. 1-2 and block 310 of FIG. 3 exemplify the operations of block 910. As another example, concept projector module 120 of FIGS. 1-2 and block 320 of FIG. 3 exemplify the operations of block 930. As another example, concept selector module 130 of FIGS. 1-2 and block 330 of FIG. 3 exemplify the operations of block 930.

In some embodiments, each model is computed (e.g., in block 920) as one of the following:
a Hidden Markov Model (HMM) with a plurality of emission states having distributions according to Gaussian Mixture Models (GMM), such as illustrated in FIG. 4;
a Dirichlet distribution;
a von Mises-Fisher distribution; or
linear or non-linear equation.
   For example, each model can be computed as one of the above-listed statistical distributions or equations that best models and/or supports the corresponding statistical characteristic of the time series of PM data.

In some of these embodiments, the plurality of emission states of the HMM correspond to a respective plurality of clusters of the time series of PM data. Furthermore, computing projections of the models onto the time series of PM data in block 930 includes the operations of sub-block 931, where the computing apparatus can compute the projection of each model based on a product of the following at each time instance over the first duration: the time series of PM data, and the posterior probabilities of the respective emission states of the HMM for the model. Some exemplary projection calculations were discussed above.

In some embodiments, computing the plurality of models in block 920 is further based on data representative of factors external to the communication network. Some example data representative of external factors was discussed above. In some of these embodiments, computing the plurality of models in block 920 includes the operations of sub-block 921, where the computing apparatus can scale or transform the time series of PM data using the data representative of the external factors. In some variants, the time series of PM data is scaled or transformed based on a function (e.g., liner or non-linear) representative of effects of the external factors on a relation between the time series of PM data and the prediction target information.

In some embodiments, selecting one or more of the models based on the projections in block 940 includes the operations of sub-blocks 941 and 944. In sub-block 941, the computing apparatus can, for each projection, calculate interaction information for data including the projection and the prediction target information. In sub-block 944, the computing apparatus can select a subset of the models corresponding to a subset of the projections whose calculated interaction information meets one or more criteria.

In some of these embodiments, each projection represents a temporal pattern of the time series of PM data that is associated with the corresponding model, and the interaction information for each projection is calculated based on a joint entropy among the temporal pattern of the time series of PM data and the prediction target information.

In other of these embodiments, selecting one or more of the models based on the projections in block 940 also includes the operations of sub-block 942, where the computing apparatus can separate the projections into first and second subsets, with projections of the first subset having greater interaction information than projections of the second subset. In such case, the first subset is selected (e.g., in sub-block 944) based on having greater interaction information.

In other of these embodiments, the interaction information for each projection includes the following: first interaction information for the projection; second interaction information for the projection and the prediction target information; and information gain from the first interaction information to the second interaction information. In such embodiments, selecting one or more of the models based on the projections in block 940 can also include the operations of sub-block 943, where the computing apparatus can separate the projections into first and second subsets, with projections of the first subset having greater information gain than projections of the second subset. In such case, the first subset is selected (e.g., in sub-block 944) based on having greater information gain.

In other embodiments, selecting one or more of the models based on the projections in block 940 includes the operations of sub-blocks 945 and 947. In sub-block 945, the computing apparatus can, for each projection, calculate a correlation between the projection and the prediction target information. In sub-block 947, the computing apparatus can select a subset of the models corresponding to a subset of the projections whose calculated correlation meets one or more criteria. In some variants, the correlation is a Pearson correlation. In other variants, the correlation is a Spearman correlation.

In some of these embodiments, selecting one or more of the models based on the projections in block 940 can also include the operations of sub-block 946, where the computing apparatus can separate the projections into first and second subsets, with projections of the first subset having greater correlation than projections of the second subset. In such case, the first subset is selected (e.g., in sub-block 947) based on having greater correlation.

In various ones of the embodiments described above, the first and second subsets can be separated (e.g., in sub-blocks 942, 943, or 946) based on a predetermined one of the following: number of projections to be included in the first subset, interaction information threshold, information gain threshold, or correlation threshold.

In some embodiments, the prediction target information is patients admitted to hospital and the time series of PM data includes samples of a plurality PM counters for each a plurality of base stations at different locations in the communication network and for each of the plurality of periodic time instances over the first duration. For example, the plurality of PM counters can include any of the following: number of active users in uplink, number of active users in downlink, total number of handovers, and total duration of all UE sessions in an area during a time interval. As more specific examples, the plurality of PM counters can include any of the following: pmActiveUeDISum, pmCellHoExeSuccLteInterF, pmCellHoExeSuccLteIntraF, pmActiveUeDISum, pmActiveUeUlSum, pmActiveUeDISum, and pmSessionTimeUe.

In other embodiments, the prediction target information is end-to-end (E2E) latency, E2E throughput, and/or energy usage for the communication network. Also, the time series of PM data includes samples of key performance indicators (KPIs) for each of a plurality of network nodes or network functions (NFs) within the communication network and for each of the plurality of periodic time instances over the first duration. In some of these embodiments, obtaining the time series of PM data in block 910 includes the operations of sub-block 911, where the computing apparatus can group the time series of PM data according to geo-location of the respective network nodes or NFs. In such embodiments, the plurality of models are computed (e.g., in block 920) based on the time series of PM data grouped according to geo-location.

In some embodiments, computing the plurality of models (e.g., in block 920) is further based on data representative of factors external to the communication network, including one or more of the following associated with the first duration: forecast or actual weather, days of the week, month of the year, season of the year, public events or demonstrations, road usage or traffic, public transportation usage, power outages, public health information (e.g., numbers or rates of vaccination, numbers or rates of positive tests for virus, numbers or rates of hospitalization, etc.), and shopping or other commerce-related information (e.g., number of store visitors, amount of sales, etc.).

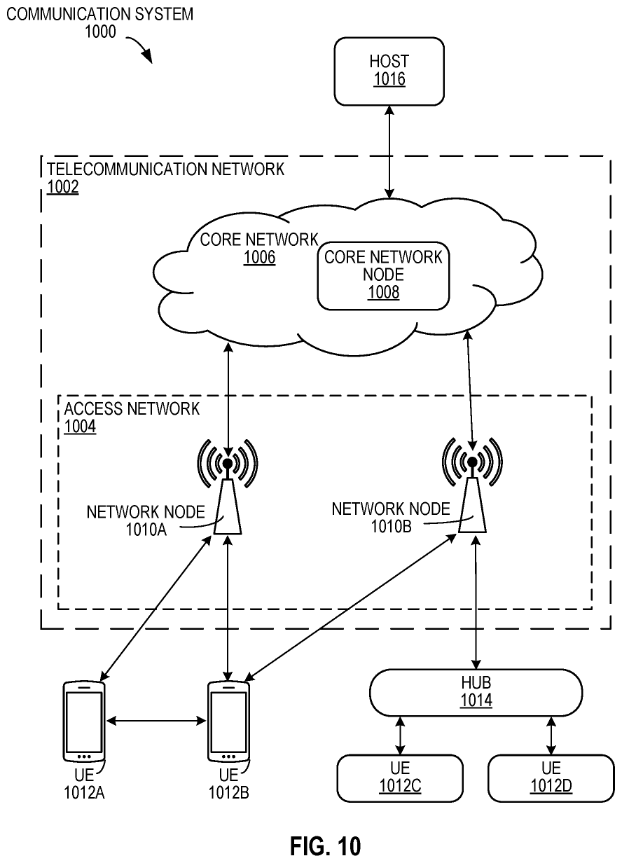

FIG. 10 shows an example of a communication system 1000 in accordance with some embodiments. In this example, the communication system 1000 includes a telecommunication network 1002 that includes an access network 1004, such as a radio access network (RAN), and a core network 1006, which includes one or more core network nodes 1008. The access network 1004 includes one or more access network nodes, such as network nodes 1010a and 1010b (one or more of which may be generally referred to as network nodes 1010), or any other similar 3GPP access node or non-3GPP access point. The network nodes 1010 facilitate direct or indirect connection of user equipment (UE), such as by connecting UEs 1012a, 1012b, 1012c, and 1012d (one or more of which may be generally referred to as UEs 1012) to the core network 1006 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 1000 may include any number of wired or wireless networks, network nodes, UEs, and/or any other components or systems that may facilitate or participate in the communication of data and/or signals whether via wired or wireless connections. The communication system 1000 may include and/or interface with any type of communication, telecommunication, data, cellular, radio network, and/or other similar type of system.

The UEs 1012 may be any of a wide variety of communication devices, including wireless devices arranged, configured, and/or operable to communicate wirelessly with the network nodes 1010 and other communication devices. Similarly, the network nodes 1010 are arranged, capable, configured, and/or operable to communicate directly or indirectly with the UEs 1012 and/or with other network nodes or equipment in the telecommunication network 1002 to enable and/or provide network access, such as wireless network access, and/or to perform other functions, such as administration in the telecommunication network 1002.

In the depicted example, the core network 1006 connects the network nodes 1010 to one or more hosts, such as host 1016. These connections may be direct or indirect via one or more intermediary networks or devices. In other examples, network nodes may be directly coupled to hosts. The core network 1006 includes one more core network nodes (e.g., core network node 1008) that are structured with hardware and software components. Features of these components may be substantially similar to those described with respect to the UEs, network nodes, and/or hosts, such that the descriptions thereof are generally applicable to the corresponding components of the core network node 1008. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 1016 may be under the ownership or control of a service provider other than an operator or provider of the access network 1004 and/or the telecommunication network 1002, and may be operated by the service provider or on behalf of the service provider. The host 1016 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a more specific example, host 1016 can perform operations corresponding to any of the exemplary methods or procedures described above in relation to FIG. 9. In some embodiments, host 1016 may be part of a cloud computing apparatus, system, or environment.

As a whole, the communication system 1000 of FIG. 10 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 1002 is a cellular network that implements 3GPP standardized features. Accordingly, the telecommunications network 1002 may support network slicing to provide different logical networks to different devices that are connected to the telecommunication network 1002. For example, the telecommunications network 1002 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 1012 are configured to transmit and/or receive information without direct human interaction. For instance, a UE may be designed to transmit information to the access network 1004 on a predetermined schedule, when triggered by an internal or external event, or in response to requests from the access network 1004. Additionally, a UE may be configured for operating in single- or multi-RAT or multi-standard mode. For example, a UE may operate with any one or combination of Wi-Fi, NR (New Radio) and LTE, i.e., being configured for multi-radio dual connectivity (MR-DC), such as E-UTRAN (Evolved-UMTS Terrestrial Radio Access Network) New Radio-Dual Connectivity (EN-DC).

In the example, the hub 1014 communicates with the access network 1004 to facilitate indirect communication between one or more UEs (e.g., UE 1012c and/or 1012d) and network nodes (e.g., network node 1010b). In some examples, the hub 1014 may be a controller, router, content source and analytics, or any of the other communication devices described herein regarding UEs. For example, the hub 1014 may be a broadband router enabling access to the core network 1006 for the UEs. As another example, the hub 1014 may be a controller that sends commands or instructions to one or more actuators in the UEs. Commands or instructions may be received from the UEs, network nodes 1010, or by executable code, script, process, or other instructions in the hub 1014. As another example, the hub 1014 may be a data collector that acts as temporary storage for UE data and, in some embodiments, may perform analysis or other processing of the data. As another example, the hub 1014 may be a content source. For example, for a UE that is a VR headset, display, loudspeaker or other media delivery device, the hub 1014 may retrieve VR assets, video, audio, or other media or data related to sensory information via a network node, which the hub 1014 then provides to the UE either directly, after performing local processing, and/or after adding additional local content. In still another example, the hub 1014 acts as a proxy server or orchestrator for the UEs, in particular in if one or more of the UEs are low energy IoT devices.

The hub 1014 may have a constant/persistent or intermittent connection to the network node 1010b. The hub 1014 may also allow for a different communication scheme and/or schedule between the hub 1014 and UEs (e.g., UE 1012c and/or 1012d), and between the hub 1014 and the core network 1006. In other examples, the hub 1014 is connected to the core network 1006 and/or one or more UEs via a wired connection. Moreover, the hub 1014 may be configured to connect to an M2M service provider over the access network 1004 and/or to another UE over a direct connection. In some scenarios, UEs may establish a wireless connection with the network nodes 1010 while still connected via the hub 1014 via a wired or wireless connection. In some embodiments, the hub 1014 may be a dedicated hub—that is, a hub whose primary function is to route communications to/from the UEs from/to the network node 1010b. In other embodiments, the hub 1014 may be a non-dedicated hub—that is, a device which is capable of operating to route communications between the UEs and network node 1010b, but which is additionally capable of operating as a communication start and/or end point for certain data channels.

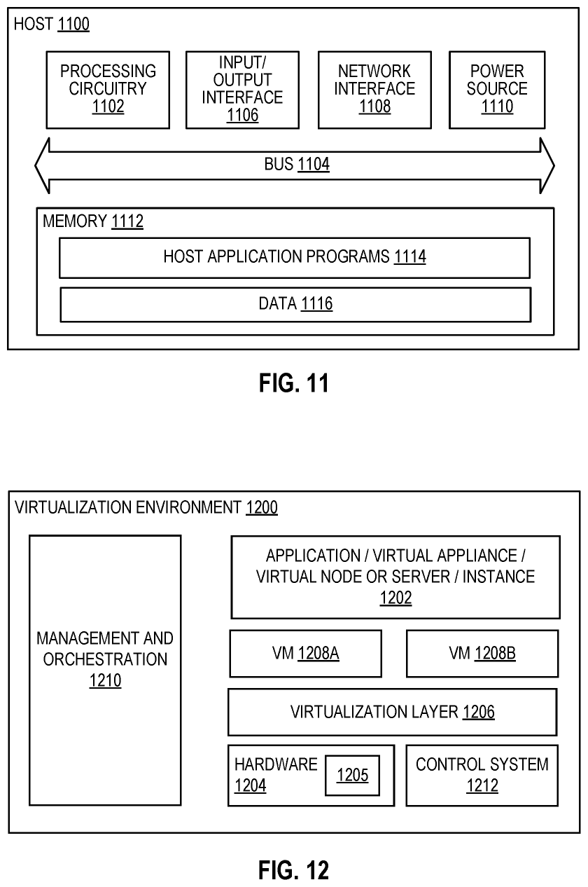

FIG. 11 is a block diagram of a host 1100, in accordance with various aspects described herein. As used herein, the host 1100 may be or comprise various combinations hardware and/or software, including a standalone server, a blade server, a cloud-implemented server, a distributed server, a virtual machine, container, or processing resources in a server farm. The host 1100 may provide one or more services to one or more UEs, to nodes or NEs of a communication network, and/or to a service provider. In some embodiments, the host may be part of a cloud computing apparatus, system, or environment.

The host 1100 includes processing circuitry 1102 that is operatively coupled via a bus 1104 to an input/output interface 1106, a network interface 1108, a power source 1110, and a memory 1112. Other components may be included in other embodiments. Features of these components may be substantially similar to those described with respect to the devices of previous figures, such as FIG. 10, such that the descriptions thereof are generally applicable to the corresponding components of host 1100.

The memory 1112 may include one or more computer programs including one or more host application programs 1114 and data 1116, which may include user data, e.g., data generated by a UE for the host 1100 or data generated by the host 1100 for a UE. Embodiments of the host 1100 may utilize only a subset or all of the components shown. The host application programs 1114 may be implemented in a container-based architecture.

As an example, the containerized host application programs may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 1114 may also provide for user authentication and licensing checks and may periodically report health, routes, and content availability to a central node, such as a device in or on the edge of a core network. Accordingly, the host 1100 may select and/or indicate a different host for over-the-top services for a UE. The host application programs 1114 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

As another example, the containerized applications running in host 1100 can include one or more applications that include operations corresponding to any of the exemplary methods or procedures described above in relation to FIG. 9.

FIG. 12 is a block diagram illustrating a virtualization environment 1200 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 1200 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 1202 (which may alternatively be called software instances, virtual appliances, network functions, virtual nodes, virtual network functions, etc.) are run in the virtualization environment 1200 to implement some of the features, functions, and/or benefits of some of the embodiments disclosed herein. As a more specific example, any of the exemplary methods or procedures described above in relation to FIG. 9 can be instantiated as an application 1202 running in virtualization environment 1200, such as in the form of an application function (AF) or a virtual network function (NF). As another specific example, virtualization environment 1200 may be (or be part of) a cloud computing system or environment that hosts various applications, including but not limited to instantiations of the exemplary methods or procedures described herein.

Hardware 1204 includes processing circuitry, memory that stores software and/or instructions (designated 1205) executable by hardware processing circuitry, and/or other hardware devices as described herein, such as a network interface, input/output interface, and so forth. Software may be executed by the processing circuitry to instantiate one or more virtualization layers 1206 (also referred to as hypervisors or virtual machine monitors (VMMs)), provide VMs 1208a and 1208b (one or more of which may be generally referred to as VMs 1208), and/or perform any of the functions, features and/or benefits described in relation with some embodiments described herein. The virtualization layer 1206 may present a virtual operating platform that appears like networking hardware to the VMs 1208.

The VMs 1208 comprise virtual processing, virtual memory, virtual networking or interface and virtual storage, and may be run by a corresponding virtualization layer 1206. Different embodiments of the instance of a virtual appliance 1202 may be implemented on one or more of VMs 1208, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 1208 may be a software implementation of a physical machine that runs programs as if they were executing on a physical, non-virtualized machine. Each of the VMs 1208, and that part of hardware 1204 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 1208 on top of the hardware 1204 and corresponds to the application 1202.

Hardware 1204 may be implemented in a standalone network node with generic or specific components. Hardware 1204 may implement some functions via virtualization. Alternatively, hardware 1204 may be part of a larger cluster of hardware (e.g., such as in a data center or CPE) where many hardware nodes work together and are managed via management and orchestration 1210, which, among others, oversees lifecycle management of applications 1202. In some embodiments, hardware 1204 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 1212 which may alternatively be used for communication between hardware nodes and radio units.

The foregoing merely illustrates the principles of the disclosure. Various modifications and alterations to the described embodiments will be apparent to those skilled in the art in view of the teachings herein. It will thus be appreciated that those skilled in the art will be able to devise numerous systems, arrangements, and procedures that, although not explicitly shown or described herein, embody the principles of the disclosure and can be thus within the spirit and scope of the disclosure. Various exemplary embodiments can be used together with one another, as well as interchangeably therewith, as should be understood by those having ordinary skill in the art.

The term unit, as used herein, can have conventional meaning in the field of electronics, electrical devices and/or electronic devices and can include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processor (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

As described herein, device and/or apparatus can be represented by a semiconductor chip, a chipset, or a (hardware) module comprising such chip or chipset; this, however, does not exclude the possibility that a functionality of a device or apparatus, instead of being hardware implemented, be implemented as a software module such as a computer program or a computer program product comprising executable software code portions for execution or being run on a processor. Furthermore, functionality of a device or apparatus can be implemented by any combination of hardware and software. A device or apparatus can also be regarded as an assembly of multiple devices and/or apparatuses, whether functionally in cooperation with or independently of each other. Moreover, devices and apparatuses can be implemented in a distributed fashion throughout a system, so long as the functionality of the device or apparatus is preserved. Such and similar principles are considered as known to a skilled person.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

In addition, certain terms used in the present disclosure, including the specification and drawings, can be used synonymously in certain instances (e.g., “data” and “information”). It should be understood, that although these terms (and/or other terms that can be synonymous to one another) can be used synonymously herein, there can be instances when such words can be intended to not be used synonymously. Further, to the extent that the prior art knowledge has not been explicitly incorporated by reference herein above, it is explicitly incorporated herein in its entirety. All publications referenced are incorporated herein by reference in their entireties.

1.-28. (canceled)

29. A computer-implemented method for identifying communication network performance management (PM) data that is explanatory of prediction target information, the method comprising:
obtaining a time series of PM data representing performance of the communication network at a plurality of periodic time instances over a first duration;
based on the time series of PM data, computing a plurality of models representing a corresponding plurality of statistical characteristics of the time series of PM data;
computing projections of the models onto the time series of PM data; and
based on the projections, selecting one or more of the models that are most explanatory of the prediction target information.

30. The method of claim 29, wherein each model is computed as one of the following:
a Hidden Markov Model (HMM) with a plurality of emission states having distributions according to Gaussian Mixture Models (GMMs);
a Dirichlet distribution;
a von Mises-Fisher distribution; or
a linear or non-linear equation.

31. The method of claim 30, wherein:
the plurality of emission states of the HMM correspond to a respective plurality of clusters of the time series of PM data; and
computing projections of the models onto the time series of PM data comprises computing the projection of each model based on a product of the following at each time instance over the first duration:
the time series of PM data, and
the posterior probabilities of the respective emission states of the HMM for the model.

32. The method of claim 29, wherein computing the plurality of models is further based on data representative of factors external to the communication network.

33. The method of claim 32, wherein:
computing the plurality of models comprises scaling or transforming the time series of PM data using the data representative of the external factors; and
the plurality of models are computed based on the scaled or transformed time series of PM data.

34. The method of claim 33, wherein the time series of PM data is scaled or transformed based on a function representative of effects of the external factors on a relation between the time series of PM data and the prediction target information.

35. The method of claim 29, wherein selecting one or more of the models based on the projections comprises:
for each projection, calculating interaction information for data including the projection and the prediction target information; and
selecting a subset of the models corresponding to a subset of the projections whose calculated interaction information meets one or more criteria.

36. The method of claim 35, wherein:
each projection represents a temporal pattern of the time series of PM data that is associated with the corresponding model; and
the interaction information for each projection is calculated based on a joint entropy among the temporal pattern of the time series of PM data and the prediction target information.

37. The method of claim 35, wherein selecting one or more of the models based on the projections further comprises separating the projections into first and second subsets, with projections of the first subset having greater interaction information than projections of the second subset, wherein the first subset is selected based on having greater interaction information.

38. The method of claim 35, wherein the interaction information for each projection includes:
first interaction information for the projection;
second interaction information for the projection and the prediction target information; and
information gain from the first interaction information to the second interaction information.

39. The method of claim 38, wherein selecting one or more of the models based on the projections further comprises separating the projections into first and second subsets, with projections of the first subset having greater information gain than projections of the second subset, wherein the first subset is selected based on having greater information gain.

40. The method of claim 29, wherein selecting one or more of the models based on the projections comprises:
for each projection, calculating a correlation between the projection and the prediction target information; and
selecting a subset of the models corresponding to a subset of the projections whose calculated correlation meets one or more criteria.

41. The method of claim 40, wherein selecting one or more of the models based on the projections further comprises separating the projections into first and second subsets, with projections of the first subset having greater correlation than projections of the second subset, wherein the first subset is selected based on having greater correlation.

42. The method of claim 37, wherein the first and second subsets are separated based on a predetermined one of the following:
number of projections to be included in the first subset,
interaction information threshold,
information gain threshold, or
correlation threshold.

43. The method of claim 29, wherein:
the time series of PM data includes samples of a plurality PM counters for each a plurality of base stations at different locations in the communication network and for each of the plurality of periodic time instances over the first duration; and
the prediction target information is patients admitted to hospital.

44. The method of claim 43, wherein the plurality of PM counters include any of the following: number of active users in uplink, number of active users in downlink, total number of handovers, and total duration of all UE sessions in an area during a time interval.

45. The method of claim 29, wherein:
the time series of PM data includes samples of key performance indicators (KPIs) for each of a plurality of network nodes or network functions (NFs) of the communication network and for each of the plurality of periodic time instances over the first duration; and
the prediction target information is one or more of the following for the communication network: end-to-end (E2E) latency, E2E throughput, and energy usage.

46. The method of claim 45, wherein:
obtaining the time series of PM data comprises grouping the time series of PM data according to geo-location of the respective network nodes or NFs; and
the plurality of models are computed based on the time series of PM data grouped according to geo-location.

47. The method of claim 32, wherein the data representative of factors external to the communication network includes data representative of one or more of the following over the first duration: forecast or actual weather, days of the week, month of the year, season of the year, public events or demonstrations, road usage or traffic, public transportation usage, power outages, public health, and shopping or other commerce.

48. A computing apparatus configured to identify communications network performance management (PM) data that is explanatory of prediction target information, the computing apparatus comprising:
communication interface circuitry arranged to communicate with a plurality of network nodes or network functions of the communication network;
processing circuitry operably coupled to communication interface circuitry and configured to:
obtain a time series of PM data representing performance of the communication network at a plurality of periodic time instances over a first duration;
based on the time series of PM data, compute a plurality of models representing a corresponding plurality of statistical characteristics of the time series of PM data;
compute projections of the models onto the time series of PM data; and
based on the projections, select one or more of the models that are most explanatory of the prediction target information.
